(19) United States
(12) Patent Application Publication
(10) Pub. No.: US 2007/0094927 A1
(43) Pub. Date: May 3, 2007

(54) Rooftop vegetation pod

(76) Inventor: Michael Perry, Virginia Beach, VA (US)

Correspondence Address: BRADLEY D. GOLDIZEN, 505 SOUTH INDEPENDENCE BOULEVARD, SUITE 102, VIRGINIA BEACH, VA, 23452, US

(21) Appl. No.: 11/589,571

(22) Filed: Oct. 30, 2006

Related U.S. Application Data
(60) Provisional application No. 60/731,781, filed on Oct. 31, 2005.

(51) Int. Cl. A01G 9/02

(52) U.S. Cl. 47/65.9

(57) ABSTRACT

A vegetation pod for creating a green roof is disclosed. The vegetation pod includes vegetation that absorbs and stores water. The roots of the vegetation grow in a growing media that rests atop a layer of filter fabric. The filter fabric is disposed within a tray that is easily handled by an installer. The tray includes a fastening mechanism that couples multiple trays together. An additional layer of absorbent material may be provided between the filter fabric and the tray. A second, preferably larger tray may be provided for accommodating a series of smaller trays. An additional layer of filter fabric may be provided between the trays.

The present application relates to U.S. Provisional Patent Application Ser. No. 60/731,781 filed on Oct. 31, 2005 and claims priority therefrom.

The present invention did not receive federal research and development funding.

### BACKGROUND OF THE INVENTION

The present invention generally relates to a lightweight green roof tray system comprising modular containment units having a geo-textile filter fabric, growing media, and a specified variety of vegetation that is used in creating a green roof. More specifically, the present invention relates to a novel green roof system that overcomes drawbacks that exist in prior art type green roof systems.

A green roof is a roof that is substantially covered with vegetation. These roofs improve energy performance of buildings, reduce storm water runoff and contribute to a healthier environment. Green roofs are a recent environmental defense used to counteract and protect against industrial waste and destructiveness created by over populating urban areas. These roofs are also a means to offset rising energy costs and meet the constant demand for increased energy efficiency. While these roofs provide benefits in all settings, their value is most well documented in urban areas.

Urban Heat Island Effect is a problematic phenomenon triggered by dark urban surfaces such as pavement and building rooftops. These surfaces tend to absorb solar energy and re-radiate it as heat. This in turn raises temperatures thereby negatively impacting the environment by raising energy costs and creating generally adverse health and well-being issues. Additionally, this phenomenon has been known to trigger dangerous thunderstorms resulting in interruption of electrical power services.

Green roofs are an effective solution to the aforementioned phenomenon in urban, as well as all other areas, because their vegetation reflects solar energy. Moreover, green roofs insulate buildings against heat loss during winter months and tend to insulate building tops to reduce cooling costs of buildings during summer months. A green roof provides shade and operates as a natural air conditioner by cooling air that surrounds the plants of the green roof. The cooling benefits reduce the temperature of the buildings, thereby reducing energy use within the building during the summer months. Similarly, the added mass of the green roof adds insulation that helps to retain heat during the winter months.

Furthermore, the vegetation absorbs rainfall and thus reduces storm water runoff that would otherwise collect pollutants and be drained into water supplies necessitating treatment of the water runoff. The vegetation and substrate also absorb various pollutants such as nitrogen, phosphorus, cadmium, copper, lead and zinc. Additionally, the plants improve air quality because they remove excess carbon dioxide while producing oxygen. Moreover, the green roof structure protects the roof from damage thus extending the useful life of the roof. Finally, green roofs add flora and fauna that is enjoyable to humans and wildlife.

Vegetation has been grown on rooftops in the past. Settlers moving westward across the prairie overcame the lack of wood necessary for building houses by constructing sod houses which typically included sod roofs. There were many drawbacks to these types of roofs including water leakage into the house during periods of rain or snow.

Many modern green roof systems include a waterproofing membrane laid on the roof. A root-resistant membrane may be provided atop the roof structure and waterproofing membrane. A filter layer of minimal thickness may be provided above the root-resistant membrane. Lastly, a layer of vegetation is disposed atop the filter layer. Previously, all of these materials were layered into one large, bulky mat, tray or earthen roll. See U.S. Pat. Nos. 6,237,285 and 6,178,690.

The prior art materials used for creating green roofs require the use of machines during installation and repair procedures. Usually, these bulky layers are lifted onto building rooftops by cranes or similar heavy lifting machinery which in turn tends to drive up the overall cost of installing and maintaining a green roof. After being deposited onto a rooftop, the vegetation layers are rolled into position through various methods. While these systems have environmental benefits, they are replete with many disadvantages. The bulky mats, trays and rolls are expensive and difficult to install because they often require large machinery and specially skilled individuals who know how to properly install them. Often, they necessitate the construction of a new roof before the layers can be installed. Moreover, the large mats, trays and rolls are not easily adapted to areas with special shapes or designs. Additionally, repairs to the roof or membrane required either large portions of the green material to be repositioned or the entire green roof to be removed.

A new wave of inventions sought to alleviate the aforementioned disadvantages. These systems introduced large enclosed modular panels that were placed on the roof. Despite some increased utility, these systems also created many new problems. These panels are still large (typically about four feet by four feet in size) and therefore must be brought to the rooftop by cranes and other heavy lifting machinery.

U.S. Pat. No. 6,711,851 introduced an enclosed modular panel with drainage holes on the bottom. In similar fashion, U.S. Pat. No. 6,862,842 revealed a method and apparatus for enclosed modular panels. While these panels enable the user to remove separate modules when repairs are necessary, they do not solve all of the previously mentioned problems and they introduced new ones.

One such new problem is that the enclosed panels tend to overflow when they are rained on or watered excessively. This overflow often causes roof damage. Another problem associated with using enclosed panels is that the enclosed structure tends to kill the plants. As plants grow their roots extend and grow out in their search for nutrients. Over time, the roots enclosed within these modular panels do not have any area to grow into and so they began to compete for the same limited nutrients. The roots have nowhere to grow thus forming a root ball that essentially suffocates and starves the plants.

Looking at the prior art, it is clear that there is a need for a new and improved green roof module that is inexpensive, can be quickly and easily installed on an existing rooftop, is easy to install and repair without the use of heavy machinery. The novel type of roof allows for adequate drainage, as well as allowing the plants to grow as nature intended.

### BRIEF SUMMARY OF THE INVENTION

The present invention overcomes all of the aforementioned problems. While successfully preserving the advantages of a green roof, it also efficiently provides the characteristics that no other prior art system possesses. In the preferred embodiment, the vegetation pod is contained within a lightweight twenty inch long by ten inch wide by two inch high (20″×10″×2″) high-strength HDPE or poly propylene plastic (or high density polyethylene) shell or tray that is easily handled by an installer. The vegetation pod is a modular containment system that comprises vegetation arranged within a growing media. A layer of geo-textile filter fabric is arranged beneath the growing media. Optional water retention pads may be arranged beneath the geo-textile filter fabric. A cross-shaped strip of adhesive may be arranged between the optional water retention pads to secure the geo-textile filter fabric to a bottom of the shell. The vegetation pod is preferably retained within sidewalls that, along with the bottom, define the shell. The sides and ends of the tray may be defined by upright strips extending parallel to one another and all of the uprights are connected together at opposite ends thereof. A top edge of the sidewalls of either the ends or sides of the trays or shells is equipped with locking strips for extending across an upper lip of an adjacent tray or shell to couple them together. The entire module is placed on top of a waterproof membrane that is disposed atop a roof.

In a second embodiment, the entire module is placed atop a filter fabric and disposed within a second tray. The second tray may comprise a framework for accommodating a plurality of vegetation pod modules. The second tray may be formed in the same manner as the shell above but in a larger dimension.

These vegetation pods are a vast improvement on the prior art for numerous reasons. First, these modules are more cost-effective and efficient because they are easily installed on and removed from roofs. The vegetation pods can simply be placed on an existing roof by hand and therefore do not require additional expenditures. They are also more cost-efficient than previous green roofs because the pods are lightweight and do not require the use of heavy machinery to lift them onto the roof. Additionally, the interlocking, separate panels can be easily removed to allow access to the underlying waterproof membrane or roof. Ultimately, this easier access also extends the useful life of the roof by not acting as an impediment to repair. Moreover, this feature makes the modules easier to maintain because if the vegetation of one module dies, that panel is merely replaced. Because of size and unique design the present invention allows the roots of the plants to grow as nature intended. The plants do not become root-bound, as they did in the prior art. Moreover, the openings in the sidewalls may allow for roots to extend from one module to another.

The instant invention also solves drainage problems with its enhanced and numerous water retention pads. The upright sections of the sidewalls may define drainage channels to allow the movement of water there through. The vegetation pod features an optional rock wool or polyurethane foam retention pad that is layered within the module and absorbs water. This retention pad saturates up to 10 pounds, and then shrinks back to its original size as it dries. This optional retention pad retains water for use by the vegetation during dry periods or drought. Thus, the life of the vegetation may be extended. Furthermore, in an additional embodiment a second water retention pad is included to assure even greater levels of water retention when desired. Also, in one embodiment, this invention utilizes a special vegetation that absorbs more water than vegetation used in the prior art.

It is an object of the invention to provide a lightweight durable tray or shell having a vegetation pod disposed therein.

It is a further object of the invention to provide a vegetation pod contained within a lightweight twenty inch long by ten inch wide by two inch high high-strength HDPE or poly propylene plastic shell or tray that is easily handled by an installer. The vegetation pod is a modular containment system that comprises vegetation arranged within a growing media. A layer of geo-textile filter fabric is arranged beneath the growing media. Optional water retention pads may be arranged beneath the geo-textile filter fabric. The vegetation pod is preferably retained within sidewalls that, along with the bottom, define the shell. The sidewalls may be defined by upright strips extending parallel to one another. A top edge of the sidewalls of either the ends or sides of the trays or shells is equipped with locking strips for extending across an upper lip of an adjacent tray or shell to couple them together.

It is an additional object of the invention to provide a module including a vegetation pod that is placed atop a filter fabric and disposed within a second tray. The second tray may comprise a framework for accommodating a plurality of modules. The second tray may be formed in the same manner as the shell above but in a larger dimension.

It is a further object of the invention to provide vegetation pods that are improvements over the prior art. The improvement includes cost effective modules that are easily installed on and removed from roofs without need heavy lifting machines. Because of size and unique design the present invention allows the roots of the plants to grow as nature intended the plants do not become root-bound, as they did in the prior art. Moreover, the openings in the sidewalls allow for roots to extend from one module to another.

It is a further object of the invention to provide vegetation pods that solves drainage problems with enhanced and numerous water retention pads. The upright sections of the sidewalls may define drainage channels to allow the movement of water there through. The vegetation pod features an optional rock wool or polyurethane foam retention pad that is layered within the module and absorbs water. This optional retention pad retains water for use by the vegetation during dry periods or drought. Thus, the life of the vegetation may be extended.

Additional objects and advantages of the invention will be set forth in part in the description which follows, and in part will be obvious from the description, or may be learned by practice of the invention. The objects and advantages of the invention will be obtained by means of instrumentalities in combinations particularly pointed out in the appended claims.

### BRIEF DESCRIPTION OF THE DRAWINGS

FIG. 1A shows an exploded view of a first embodiment of the vegetation pod.

FIG. 1 B shows an exploded view of a second embodiment of the vegetation pod.

FIG. 1C shows an embodiment of the invention wherein the vegetation pod components does not include any water retention pads and an additional larger base shell for accommodating several pods.

FIG. 1D shows the embodiment of FIG. 1C with additional absorption pads.

FIG. 2A is a perspective view of 1 vegetation pod with all of its components within its shell.

FIG. 2B is an enlarged view of a corner of the vegetation pod.

FIG. 3A portrays 2 vegetation pods interlocked on their sides via a coupling mechanism arranged on an upper edge of each side of the tray.

FIG. 3B is a cross section view taken from line A-A of FIG. 3A.

FIG. 4 shows 4 vegetation pods interlocked on all sides via coupling mechanisms.

FIG. 5 illustrates a series of vegetation pods interlocked and positioned on a roof.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

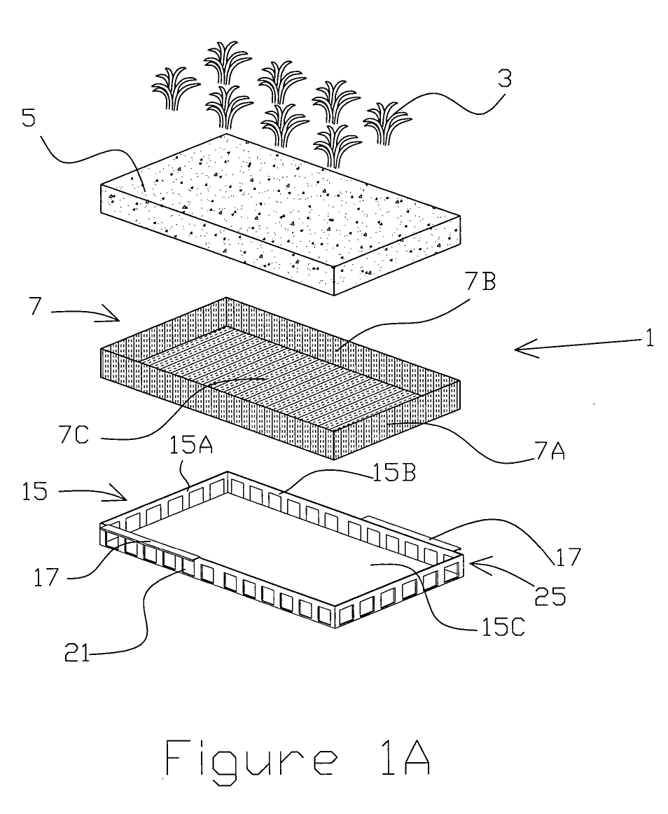

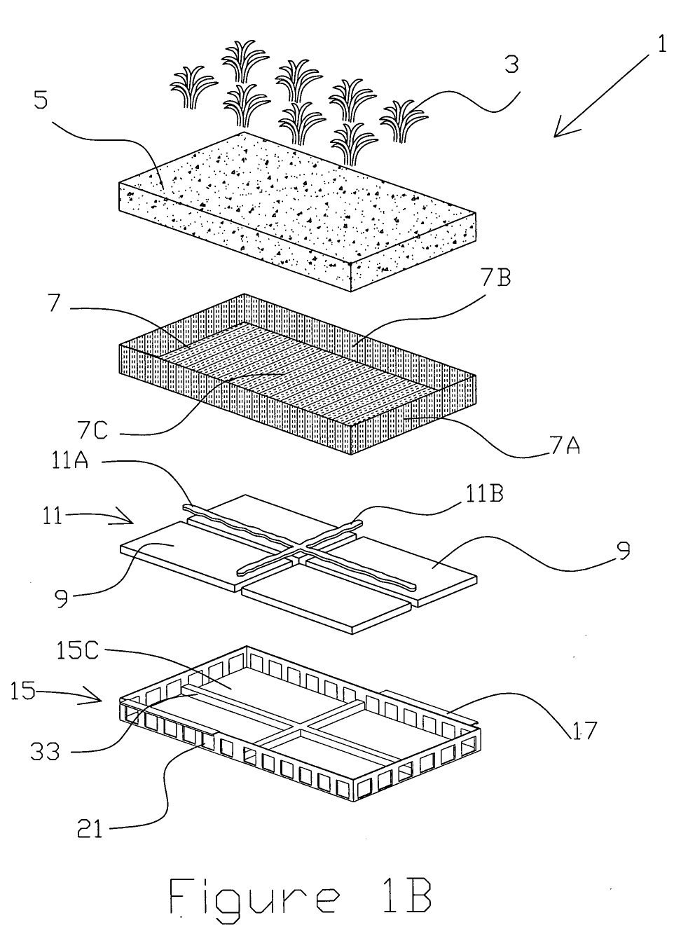

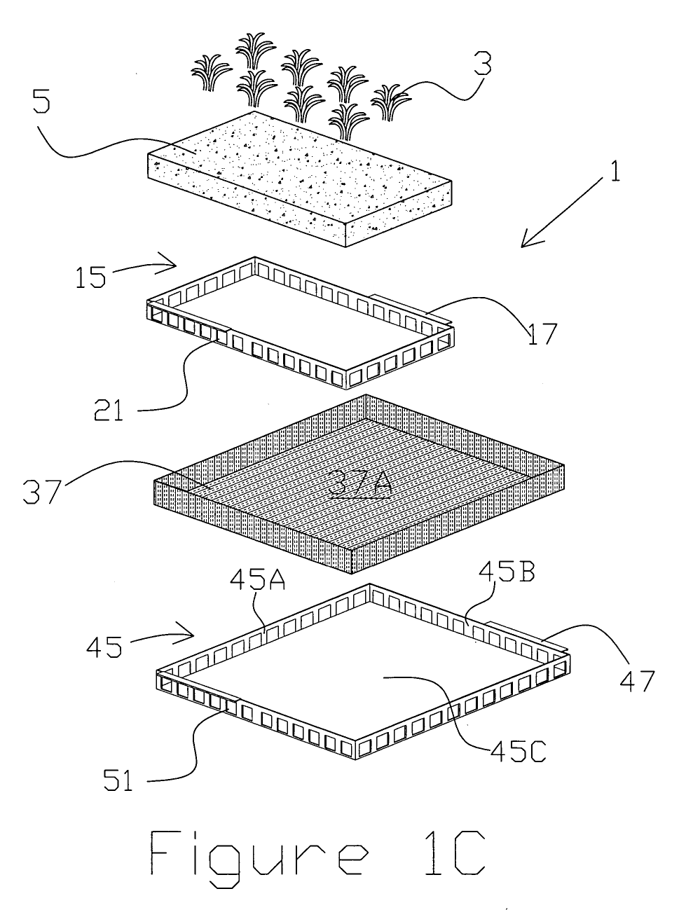

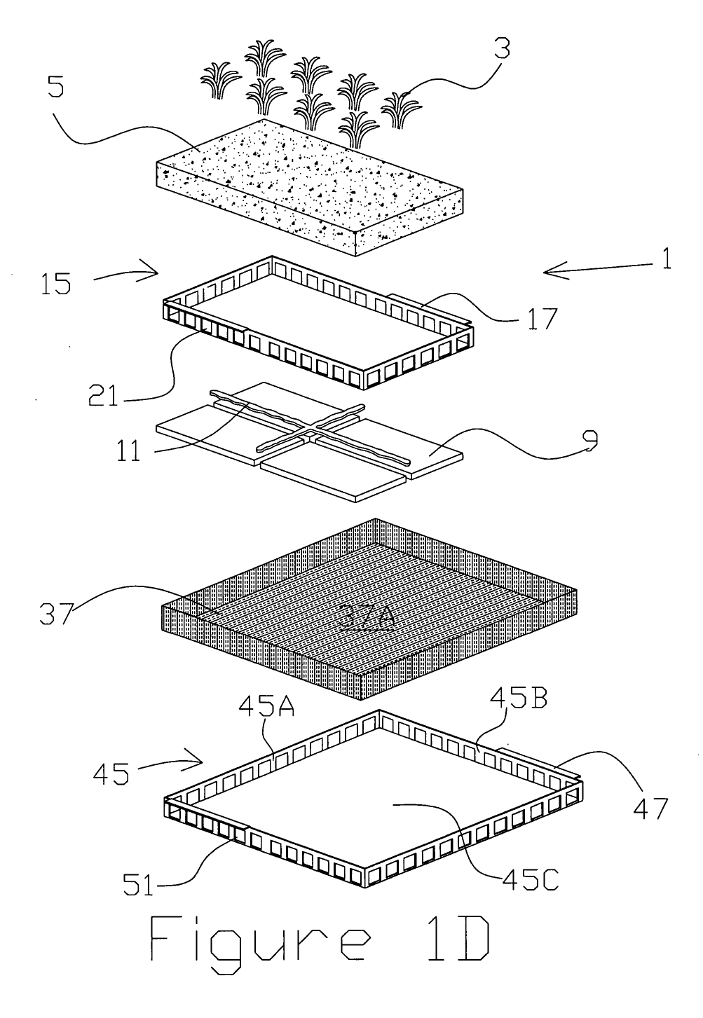

FIG. 1A is an exploded view of a vegetation pod 1 shown assembled in FIG. 2A. The pod 1 includes vegetation 3 having a lower end that includes roots that extend into the growing media 5 for receiving nutrients. Preferably, the vegetation is a sedum type or other such succulent vegetation that store water in their leaves. The growing media may comprise any nutrient laden media that provides nutrients to the plants and may include combinations of soils, rocks, or other lightweight material into which the roots may grow to provide a stable base for the vegetation. Moreover, liquid nutrients may be sprayed onto the plants or growing media or otherwise deposited such that the plants receive essential nutrients as necessary. The growing media 5 typically comprises a mixture of soil and rock complying with ASTM-D422.

Growing media 5 is deposited atop filter fabric 7. Filter fabric 7 includes a top surface 7A which is also the inner surface with respect to tray 15 when the vegetation pod is assembled. This inner surface comes into contact with the growing media 5 and helps to retain the media within the tray such that it does not spill through the openings provided in the sidewalls of the tray. A bottom surface of the filter fabric 7 comes into contact with an inner surface of tray 15. The surface areas of the top and bottom surfaces of the filter fabric are substantially equal in size. Moreover, the combined surface area of the inner surface of bottom 15C, ends 15A, and sides 15B substantially equals the surface area of either the top or bottom surface of the filter fabric 7. In this manner, the filter fabric 7 tends to form a box shape and having ends 7A, sides 7B and bottom 7C when placed in the tray and formed thereto while depositing media therein. The filter fabric 7 is preferably a needle punched non-woven polypropylene geotextile fabric that complies with ASTM-D4491.

Tray 15 comprises ends 15A, sides 15B and bottom 15C. Corners 25 are shown more clearly in FIG. 2B and discussed hereinafter. The tray 15 is preferably formed from high-strength HDPE, poly propylene plastic or high density polyethylene. In the embodiment shown in FIG. 1A, the tray 15 is formed in a rectangular shape having the dimensions of twenty inches long by ten inches wide by two inches high (20″×10″×2″). In this embodiment, the tray bottom 15C is flat.

FIG. 1B is an exploded view of a second embodiment of a vegetation pod 1. The vegetation pod comprises vegetation 3. As mentioned above, the vegetation is preferably a sedum type or other such succulent vegetation that stores water in their leaves. The vegetation is planted in a growing media 5 that is disposed above a filter fabric 7. As referenced above, the growing media 5 typically comprises a mixture of soil and rock complying with ASTM-D422. Preferably, the filter fabric 7 is a needle punched non-woven polypropylene geotextile fabric that complies with ASTM-D 4491.

Absorbent material 9 is optionally disposed between tray bottom 15C and filter fabric 7. The absorbent material 9 retains and stores water to be released to the vegetation 3. The absorbent material 9 is preferably rock wool and is preferably provided in four pieces, as shown in FIG. 1B. The tray bottom 15C includes a raised cross-shaped region 33 that divides the tray bottom 15C into four equally sized areas. Each piece of absorbent material 9 is deposited within a particular area of the tray bottom 15C. The absorbent material 9 allows water to be absorbed by the roots of the vegetation to assume its original size and shape.

A layer of adhesive 11 comprises adhesive members 11A and 11B and is provided for securing the filter fabric 7 to the raised cross-shaped region 33. Openings 21 are included in the sidewalls of the sides 15B and ends 15A of tray 15 for allowing drainage when the vegetation 3 and rock wool 9 become saturated. These openings may operate as drainage channels 21 for directing the water from the rooftop. Each tray 15 includes a fastening lip 17 that overlaps an upper edge 40 of other trays position on either side to couple them together to form an integral unit.

FIG. 1C shows an additional embodiment of the invention wherein the vegetation 3 is planted in the growing media 5. The growing media 5 is deposited into the tray 15 which includes fastening lip 17 as mentioned above. In this embodiment, a large sheet of filter fabric 37 is deposited below the tray 15. This filter fabric 37 includes a top surface 37A which is also the inner surface with respect to tray 45. This inner surface comes into contact with the bottom and exterior surfaces of the ends and sides of tray 15. A bottom surface of the filter fabric 37 comes into contact with an inner surface of tray 45. The surface areas of the top and bottom surfaces of the filter fabric 37 are substantially equal. Moreover, the combined surface area of the inner surface of bottom 45C, ends 45A, and sides 45B substantially equals the surface area of either surface of the filter fabric 37. In this manner, the filter fabric 37 tends to form a box shape and having ends 37A, sides 37B and bottom 37C when tray 15 is inserted into tray 45 and above the filter fabric 37 as shown. The filter fabric 37 is preferably a needle punched non-woven polypropylene geotextile fabric that complies with ASTM-D 4491. The dimensions of tray 45 are substantially twice the dimensions of tray 15 for accommodating two vegetation pods 1 therein. However, it is to be recognized that the dimensions of tray 45 may be increased by any whole number. An enlarged fastener 47 is arranged on opposite sides of the tray 47 at opposite ends thereof. Enlarged openings 51 are included in tray 45 for allowing the movement of water between adjacent trays 47.

In a further embodiment as shown in FIG. 1D, the optional adhesive 11 and absorbent material 9 is arranged below the bottom of tray 15 and above the filter fabric 37. The cross-shaped adhesive strip 11 includes a thickness that is substantially equal to the thickness of each piece of absorbent material 9. In this manner, the adhesive not only holds adjacent sides of separate absorbent materials 9 together, but it also secures the bottom of tray 15 to the top of filter fabric 37. The absorbent material 9 may be the same as that of the previous embodiments just provided in an enlarged form.

FIG. 2A reflects preferred dimensions of the vegetation pod 1. The vegetation pod 1 is contained within a lightweight twenty inch long (L) by ten inch wide (W) by two inch high (HT) (20″×10″×2″) high-strength HDPE or poly propylene plastic or high density polyethylene tray that is easily handled by an installer as shown. FIG. 2B is an enlarged view of a corner of the tray

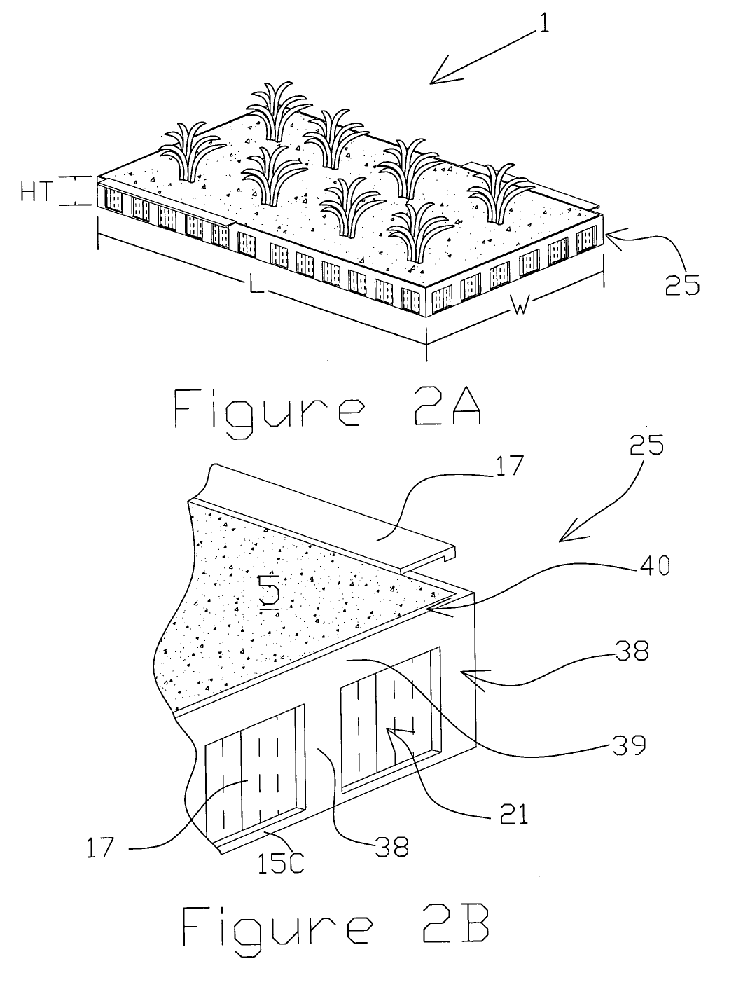

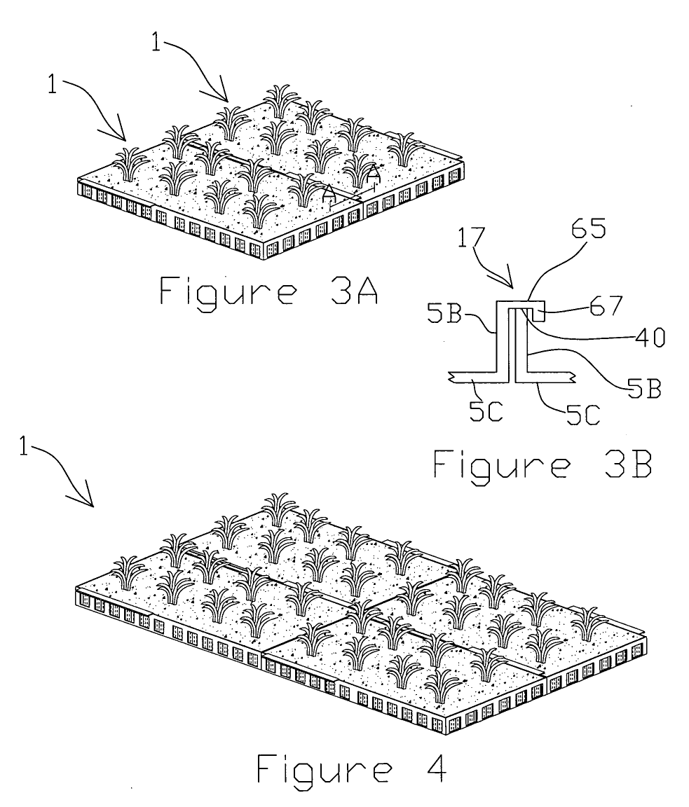

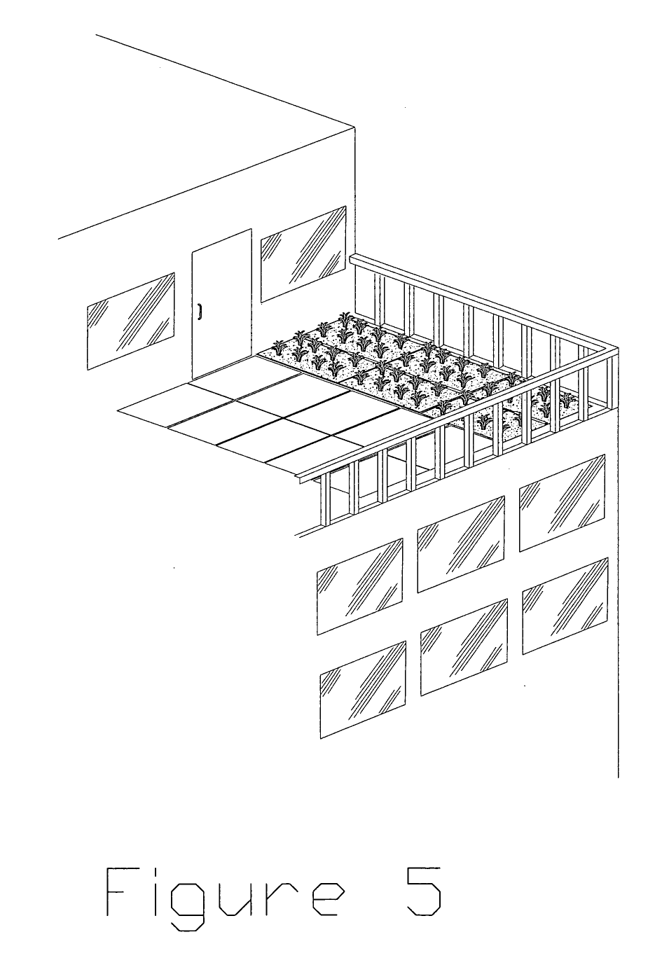

FIG. 2B is a partial end view of a corner 25 of either tray 15 or tray 45. For ease in understanding the invention, the reference to tray 45 has been omitted. It is to be understood that where the numerals 15 appear in reference to this drawing, the skilled artisan can appreciate that numerals 45 may be inserted therefore in providing the larger tray. The sidewalls of the ends and sides of the tray comprise a plurality of upright supports 38 that are commonly fastened at a top end together by cross member 39. A bottom end of each upright support 38 is fixed to the bottom of the tray 5C. The tray may be molded, extruded or formed from a single sheet of material. The openings 21 advantageously reduce the overall weight of the vegetation pod such that an installer can easily handle the vegetation pods or trays. The number of openings may be varied as understood by the skilled artisan. However, the openings on each side of the tray may preferably equal 10-12; while the openings on each end of the tray may preferably equal 4-6. An upper edge 40 is provided around the entire tray and may receive an overlapping fastening device as discussed with respect to FIG. 3B.

FIG. 3A shows a pair of vegetation pods coupled together via a coupling means provided in the form of an overlapping fastening lip 17. As more clearly shown in FIG. 3B, the fastening lip 17 extends from a sidewall 5B of one tray 5B and across an upper edge 40 of a second tray sidewall 5B. The overlapping fastening lip 17 includes an extension member 65 that comprises a perpendicular fastening surface 67. Once overlapped, the fastening lip 17 secures the pair of vegetation pods together. In this manner pods can be securely attached together within a larger tray which then attaches to larger adjacent trays to form an array of vegetation pods as shown in FIG. 4. This array of vegetation pods may be assembled on a rooftop as shown in FIG. 5.

While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A vegetation pod for use in a green roof, said vegetation pod comprising:
vegetation having leaves and a lower end that includes roots;
a growing media having nutrients that are provided to the vegetation via the roots;
a filter fabric having a top surface that is in contact with the growing media, said filter fabric comprising a bottom surface;
a tray having two sides, two ends and a bottom, each of the two sides and the two ends comprise a sidewall having an upper lip, said sidewall including openings that are formed therein; and,
a fastener arranged on the upper lip of the sidewall that fastens the vegetation pod to adjacent vegetation pods to form an integral unit.

2. The vegetation pod of claim 1 wherein said vegetation is sedum vegetation or succulent vegetation that stores water in the leaves.

3. The vegetation pod of claim 1 wherein said growing media comprises any nutrient laden material that provides nutrients to the vegetation.

4. The vegetation pod of claim 3 wherein said growing media comprises a combination of soil and rocks.

5. The vegetation pod of claim 1 wherein said growing media comprises a mixture of soil and rock complying with ASTM-D422.

6. The vegetation pod of claim 1 wherein said filter fabric is a needle-punched non-woven polypropylene geotextile fabric that complies with ASTM-D4491.

7. The vegetation pod of claim 1 wherein said tray comprises one or more selected from a group consisting of high-strength HDPE, poly propylene plastic and high density polyethylene.

8. The vegetation pod of claim 1 wherein said tray is a rectangular shape having the dimensions of twenty inches long by ten inches wide by two inches high (20″×10″×2″).

9. The vegetation pod of claim 1 wherein said tray comprises a flat bottom.

10. The vegetation pod of claim 1 further comprising an absorbent material that retains and stores water to be released to the vegetation, said absorbent material being disposed between the tray bottom and the filter fabric.

11. The vegetation pod of claim 10 wherein the absorbent material is rock wool.

12. The vegetation pod of claim 11 wherein said absorbent material is in four equally sized pieces.

13. The vegetation pod of claim 12 wherein said tray bottom includes a raised cross-shaped region that divides the tray bottom into four equally sized areas.

14. The vegetation pod of claim 1 further comprising a layer of adhesive disposed between the filter fabric and the bottom of the tray.

15. The vegetation pod of claim 1 wherein said fastener comprises an extension member that comprises a perpendicular fastening surface.

16. A vegetation pod for use in a green roof, said vegetation pod comprising:
vegetation having leaves and a lower end that includes roots, said vegetation being succulent vegetation that stores water in the leaves;
a growing media having nutrients that are provided to the vegetation via the roots, said growing media comprising a mixture of soil and rock complying with ASTM-D 422;
a filter fabric having a top surface that is in contact with the growing media, said filter fabric comprising a bottom surface, said filter fabric is a needle-punched non-woven polypropylene geotextile fabric that complies with ASTM-D4491;
a tray having two sides, two ends and a bottom, each of the two sides and the two ends comprise a sidewall having an upper lip, said sidewall including openings that are formed therein by a plurality of upright supports, each upright support having an upper end that connects to adjacent upright supports; and,
a fastener arranged on the upper lip of the sidewall that fastens the vegetation pod to adjacent vegetation pods to form an integral unit.

17. The vegetation pod of claim 16 further comprising an absorbent material that retains and stores water to be released to the vegetation, said absorbent material being disposed between the tray bottom and the filter fabric.

18. The vegetation pod of claim 16 wherein the fabric material is arranged between the bottom of the tray and a second larger tray.

19. A vegetation pod for use in a green roof, said vegetation pod comprising:
vegetation having leaves and a lower end that includes roots, said vegetation being succulent vegetation that stores water in the leaves;
a growing media having nutrients that are provided to the vegetation via the roots, said growing media comprising a mixture of soil and rock complying with ASTM-D 422;
a filter fabric having a top surface that is in contact with the growing media, said filter fabric comprising a bottom surface, said filter fabric is a needle-punched non-woven polypropylene geotextile fabric that complies with ASTM-D4491;
a tray having two sides, two ends and a bottom, each of the two sides and the two ends comprise a sidewall having an upper lip, said sidewall including openings that are formed therein;
adhesive arranged between said filter fabric and said tray; and,
a fastener arranged on the upper lip of the sidewall that fastens the vegetation pod to adjacent vegetation pods to form an integral unit.

20. The vegetation pod of claim 19 further comprising a plurality of absorbent material that retains and stores water to be released to the vegetation, said absorbent material being disposed between the tray bottom and the filter fabric and having said adhesive arranged within said plurality of absorbent material to secure the filter fabric to the tray.
